(19) United States
(12) Patent Application Publication
(10) Pub. No.: US 2023/0073306 A1
(43) Pub. Date: Mar. 9, 2023

(54) CULTURE SHEET, CULTURE KIT, AND METHOD OF MANUFACTURING CULTURE SHEET

(71) Applicant: SEIKO EPSON CORPORATION, Tokyo (JP)

(72) Inventors: Hisashi KOIKE, Suwa (JP); Akio ITO, Matsumoto (JP); Toshiaki MIKOSHIBA, Azumino (JP)

(21) Appl. No.: 17/929,325

(22) Filed: Sep. 2, 2022

(30) Foreign Application Priority Data
Sep. 6, 2021 (JP) 2021-144559

(51) Int. Cl. A01G 24/46; A01G 24/23; B32B 5/02; B32B 29/02; B32B 3/26; B32B 7/12

(52) U.S. Cl. CPC A01G 24/46; A01G 24/23; B32B 5/022; B32B 29/02; B32B 3/266; B32B 7/12; B32B 2250/03; B32B 2262/062; B32B 2307/728; B32B 2307/734; B32B 2410/00

(57) ABSTRACT

Provided is a culture sheet including: a fiber layer including cellulose fibers and a natural bonding agent that bonds the cellulose fibers; and nonwoven paper that supports the fiber layer.

The present application is based on, and claims priority from JP Application Serial Number 2021-144559, filed Sep. 6, 2021, the disclosure of which is hereby incorporated by reference herein in its entirety.

### BACKGROUND

### 1. Technical Field

The present disclosure relates to a culture sheet, a culture kit, and a method of manufacturing a culture sheet.

### 2. Related Art

Plant culture sheets containing fibers and additives are known. JP-A-2019-131912 discloses a plant culture sheet. The plant culture sheet is a sheet for cultivating plants and mushrooms. The plant culture sheet includes, as the fibers, fibers prepared by defibrating used paper, waste paper, or pulp sheets. Meanwhile, the plant culture sheet includes a granular fertilizer, a pH adjuster, a moisture retaining material, and the like as additives.

When a user cultivates a plant by using such a plant culture sheet, the plant culture sheet has to retain moisture. Although the moisture retaining material for retaining the moisture is added to the plant culture sheet according to JP-A-2019-131912, this plant culture sheet may fail to retain sufficient moisture in some cases.

### SUMMARY

A culture sheet of the present disclosure includes: a fiber layer including cellulose fibers and a natural bonding agent that bonds the cellulose fibers; and nonwoven paper that supports the fiber layer.

A culture kit of the present disclosure includes: a fiber assembly including cellulose fibers and a first natural bonding agent that bonds the cellulose fibers; and a sheet including a fiber layer including cellulose fibers and a second natural bonding agent that bonds the cellulose fibers, and nonwoven paper that supports the fiber layer, in which the sheet covers the fiber assembly.

A method of manufacturing a culture sheet of the present disclosure includes: defibrating a raw material that includes cellulose fibers by dry defibration; producing a mixture by mixing the cellulose fibers defibrated by the dry defibration with a natural bonding agent; producing a layered body by using the mixture produced and nonwoven paper; and producing a sheet by applying heat and pressure to the layered body.

### BRIEF DESCRIPTION OF THE DRAWINGS

FIG. 1 is a diagram illustrating a configuration of a molded body manufacturing apparatus.

FIG. 2 is a diagram illustrating configurations of a transporting portion, a sieve portion, and a second web forming portion.

FIG. 3 is a diagram illustrating a configuration of a sheet.

FIG. 4 is a diagram illustrating a configuration of a sheet.

FIG. 5 is a diagram illustrating a configuration in which the sheet is subjected to surface processing.

FIG. 6 is a diagram illustrating a configuration in which the sheet is subjected to surface processing.

FIG. 7 is a diagram illustrating a flowchart for forming the sheet.

FIG. 8 is a diagram illustrating a configuration of a fiber processed product including the sheet.

### DESCRIPTION OF EXEMPLARY EMBODIMENTS

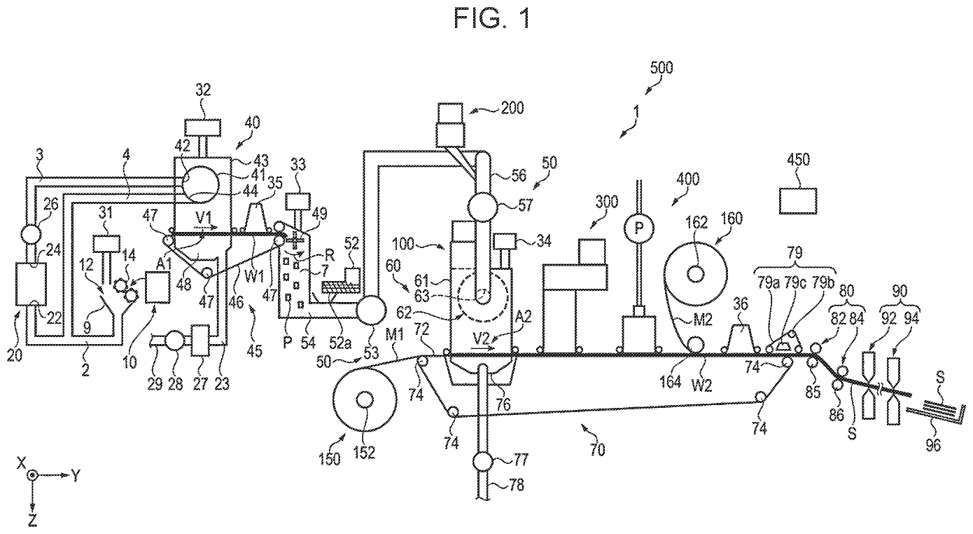

FIG. 1 illustrates a configuration of a molded body manufacturing apparatus 500. The molded body manufacturing apparatus 500 manufactures a molded body by subjecting a raw material to dry defibration so as to be formed into fibers and then applying pressure and heat to the fibers and cutting the fibers. The molded body manufacturing apparatus 500 can mix various additives into the defibrated raw material. By adding such additives, a manufacturer improves bonding strength or whiteness, adds colors or scents, and adds functionality, such as flame resistance, in conformity with the usage of the molded body. The molded body manufacturing apparatus 500 can control density, thickness, and shape of the molded body. The molded body manufacturing apparatus 500 can manufacture office paper sheets having sizes of A4 and A3, paper sheets having various thicknesses and sizes, such as business cards, and molded bodies used for liquid absorption. The molded body manufacturing apparatus 500 illustrated in FIG. 1 manufactures a sheet S or a fiber aggregate body FC.

As illustrated in FIG. 1, the molded body manufacturing apparatus 500 includes a web forming apparatus 1, a transferring portion 79, a molded body forming portion 80, a cutting portion 90, and a receiving portion 96. The web forming apparatus 1 includes a raw material supplying portion 10, a coarse crushing portion 12, a defibrating portion 20, a sizing portion 40, a first web forming portion 45, a rotating body 49, a transporting portion 50, a sieve portion 60, a second web forming portion 70, a first supplying portion 100, a second supplying portion 200, a third supplying portion 300, and a fourth supplying portion 400.

Some of the drawings including FIG. 1 illustrate the XYZ coordinate system. The X-axis, the Y-axis, and the Z-axis are orthogonal to one another. The X-axis is an axis which is parallel to an installation plane of the molded body manufacturing apparatus 500 and orthogonal to a direction of transportation of a second web W2 to be transported by the second web forming portion 70. The second web W2 will be described later. A direction from back to front in FIG. 1 is the +X direction. A direction from front to back in FIG. 1 is the −X direction. The Y-axis is an axis which is parallel to the installation plane of the molded body manufacturing apparatus 500 and parallel to the direction of transportation of the second web W2 to be transported by the second web forming portion 70. The direction of transportation of the second web W2 to be transported by the second web forming portion 70 is the +Y direction. A direction opposite to the direction of transportation of the second web W2 to be transported by the second web forming portion 70 is the −Y direction. The Z-axis is an axis which is perpendicular to the installation plane of the molded body manufacturing apparatus 500. A direction from above to the installation plane is the +Z direction. A direction from the installation plane to above is the −Z direction.

The molded body manufacturing apparatus 500 includes a humidification mechanism for humidifying the raw material, the second web W2, and the like. The humidification mechanism includes a first humidifying portion 31, a second humidifying portion 32, a third humidifying portion 33, a fourth humidifying portion 34, a fifth humidifying portion 35, and a sixth humidifying portion 36. The humidification mechanism suppresses adhesion of the raw material, the second web W2, and the like into the molded body manufacturing apparatus 500 due to static electricity. Each of the first humidifying portion 31, the second humidifying portion 32, the third humidifying portion 33, and the fourth humidifying portion 34 is formed of a humidifier of a vaporization type or a warm air vaporization type, for example. Each of the fifth humidifying portion 35 and the sixth humidifying portion 36 is formed of an ultrasonic humidifier, for example.

The molded body manufacturing apparatus 500 includes a control portion 450. The control portion 450 controls the respective portions included in the web forming apparatus 1, the transferring portion 79, the molded body forming portion 80, the cutting portion 90, and the humidification mechanism.

The raw material supplying portion 10 supplies the raw material to the coarse crushing portion 12. The raw material to be supplied to the coarse crushing portion 12 may be any material as long as it contains fibers. For example, the raw material supplying portion 10 illustrated in FIG. 1 includes a stacker on which paper, such as used paper, is to be stacked and stored, and an automated loading device that sends out the paper from the stacker to the coarse crushing portion 12.

The coarse crushing portion 12 includes a pair of coarse crushing blades 14 and a not-illustrated coarse crushing blade driving portion. The coarse crushing portion 12 cuts the raw material supplied by the raw material supplying portion 10 with the pair of coarse crushing blades 14 into coarsely crushed pieces. The pair of coarse crushing blades 14 pinch and cut the raw material into pieces. The pair of coarse crushing blades 14 cut the raw material in a gas, such as air. The coarsely crushed pieces may have any shapes or sizes as long as the crushed pieces are suitable for defibration processing in the defibrating portion 20. The coarse crushing portion 12 cuts the raw material into paper piece sizes of one to several centimeters square or into smaller sizes. The coarsely crushed pieces cut by the coarse crushing portion 12 are passed through a first pipe 2 via a chute 9 and are transported to the defibrating portion 20.

The defibrating portion 20 defibrates the coarsely crushed pieces cut by the coarse crushing portion 12. The defibrating portion 20 produces a defibrated material by subjecting the coarsely crushed pieces to the defibration processing. Here, the term “defibration” means to untangle each coarsely crushed piece in which fibers are bound to one another into individual fibers. The defibrating portion 20 has a function to separate substances adhering to the coarsely crushed pieces, such as resin particles, inks, toner, and pounce from the fibers.

In addition to the untangled fibers, the defibrated material produced by the defibrating portion 20 may include the resin particles separated from the fibers during the course of untangling the fibers. Examples of the resin particles include additives, such as binding resin particles that bind the fibers to one another, coloring materials, such as inks and toner, pounce, and strengthening agents. The untangled defibrated material has a shape of a cord or a tape. The defibrated material may be present in a state of the fibers not being entwined with one another or, in other words, in a state of a group of fibers including independent fibers. The defibrated material may be present in a state where the defibrated fibers are entwined with one another into a massive form, that is, in a group of fibers forming a clump.

The defibrating portion 20 performs defibration in accordance with a dry method. The dry method means to carry out the processing in a gas, such as air, instead of in a liquid, such as water. The defibrating portion 20 is formed of an impeller mill, for example. Although not illustrated, the defibrating portion 20 includes a rotor that rotates at a high speed and a liner located on an outer periphery of the rotor. The coarsely crushed pieces cut by the coarse crushing portion 12 are defibrated by being pinched between the rotor and the liner of the defibrating portion 20.

The defibrating portion 20 generates an airflow by the rotation of the rotor. Using the generated airflow, the defibrating portion 20 suctions the coarsely crushed pieces from the first pipe 2 through a coarsely crushed piece inlet 22. The defibrating portion 20 discharges the defibrated material from a defibrated material discharge port 24 by using the airflow. The defibrated material is sent out from the defibrated material discharge port 24 to a second pipe 3 and is transported to the sizing portion 40 through the second pipe 3. The molded body manufacturing apparatus 500 illustrated in FIG. 1 includes a defibration blower 26 serving as an airflow generator. The defibration blower 26 transports the defibrated material to the sizing portion 40 by using the generated airflow.

The sizing portion 40 is provided with a defibrated material inlet 42. The defibrated material inlet 42 takes in the defibrated material from the second pipe 3, which is defibrated by the defibrating portion 20. The sizing portion 40 sorts the defibrated material taken in from the defibrated material inlet 42 according to the size of the defibrated material particles. Of the defibrated material thus taken in, the sizing portion 40 sorts defibrated material particles equal to or smaller than a predetermined size as a first sized material. Of the defibrated material thus taken in, the sizing portion 40 sorts defibrated material particles larger than the first sized material as a second sized material. The first sized material includes fibers, particles, and the like which are smaller than a predetermined length. The second sized material includes at least one kind of the fibers larger than the predetermined length, undefibrated pieces, the coarsely crushed pieces that are yet to be fully defibrated, a reaggregated material of the defibrated fibers, a clump of entwined fibers, and the like. The sizing portion 40 illustrated in FIG. 1 includes a first drum portion 41 and a first housing 43 that houses the first drum portion 41.

The first drum portion 41 is a cylindrical sieve which is rotated by a motor. The first drum portion 41 includes not-illustrated mesh and functions as the sieve. The first drum portion 41 sorts the defibrated material into the first sized material larger than each mesh opening and into the second sized material larger than the mesh opening.

The defibrated material taken in from the defibrated material inlet 42 is sent into the first drum portion 41. The first sized material falls below from the mesh openings of the first drum portion 41 along with the rotation of the first drum portion 41. The second sized material that cannot pass through the mesh openings of the first drum portion 41 is blown by the airflow that flows from the defibrated material inlet 42 into the first drum portion 41 and is thus guided to a sized material discharge port 44 and sent out to a third pipe 4. The third pipe 4 links the inside of the first drum portion 41 to the first pipe 2. The second sized material sent to the third pipe 4 is returned to the defibrating portion 20 and is subjected to the defibration processing again.

The first sized material sorted by the first drum portion 41 passes through the mesh openings of the first drum portion 41 and is dispersed into the air. The dispersed first sized material falls toward a first mesh belt 46 of the first web forming portion 45 which is located below the first drum portion 41.

The first web forming portion 45 includes the first mesh belt 46, belt transportation rollers 47, and a first suctioning portion 48. The first mesh belt 46 is an endless belt. The first mesh belt 46 illustrated in FIG. 1 is wound around the three belt transportation rollers 47. The first mesh belt 46 is transported in a direction indicated by a first arrow A1 by rotation of the belt transportation rollers 47. A surface of the first mesh belt 46 is formed of a net in which openings of a predetermined sizes are arranged. Of the first sized material falling from the sizing portion 40, fine particles each having a size so as to pass through the openings fall to below the first mesh belt 46. A first web W1 is formed by accumulation on the first mesh belt 46 of the defibrated material particles in sizes that cannot pass through the openings. The first web W1 formed on the first mesh belt 46 is transported in the direction indicated by the first arrow A1. The fine particles falling from the first mesh belt 46 are particles included in the defibrated material, which are smaller than the predetermined size. The falling fine particles are the fibers and the resin particles that remain between the fibers. The falling fine particles are removed substances that are not used for manufacturing the sheet S.

The first mesh belt 46 moves at a predetermined first velocity V1 during normal operation of manufacturing the sheet S. Normal operation is operation excluding start control and stop control of the molded body manufacturing apparatus 500.

The first suctioning portion 48 suctions air from a position in the +Z direction of the first mesh belt 46. The first suctioning portion 48 is joined to a dust collecting portion 27 through a suction pipe 23. The dust collecting portion 27 is a dust collection unit of a filter type or a cyclone type. The dust collecting portion 27 separates the fine particles from the airflow. A collection blower 28 is installed downstream of the dust collecting portion 27. The collection blower 28 functions as a suctioning system for dust collection to suction air from the dust collecting portion 27. Air discharged from the collection blower 28 is discharged to the outside of the molded body manufacturing apparatus 500 through a discharge pipe 29.

Air containing mist is supplied from the fifth humidifying portion 35 to the first web W1 formed on the first mesh belt 46. The mist containing fine particles of water generated by the fifth humidifying portion 35 falls toward the first web W1. The fifth humidifying portion 35 supplies moisture to the first web W1. The fifth humidifying portion 35 adjusts the amount of moisture contained in the first web W1, thereby suppressing adhesion of the fibers and the like to the first mesh belt 46 due to static electricity.

The molded body manufacturing apparatus 500 includes the rotating body 49 that severs the first web W1 formed on the first mesh belt 46. The first web W1 is peeled off the first mesh belt 46 at a position where the first mesh belt 46 doubles back at one of the belt transportation rollers 47. The first web W1 thus peeled off is severed by the rotating body 49.

The rotating body 49 includes a rotating member provided with plate-like vanes. The rotating body 49 is disposed at such a position that the vanes come into contact with the first web W1 being peeled off the first mesh belt 46. Rotation of the rotating body 49 in a rotational direction R illustrated in FIG. 1 causes the vanes to strike and sever the first web W1. Segments P are produced by causing the rotating body 49 to sever the first web W1. The segments P represent an example of fibers used as a main raw material when forming the second web W2 and the sheet S to be described later. The segments P severed by the rotating body 49 are transported to the transporting portion 50 by an airflow that flows inside a fourth pipe 7.

As illustrated in FIG. 1, the transporting portion 50 includes an additive supplying portion 52, a first transportation pipe 54, and a mixing blower 53. The additive supplying portion 52 supplies an additive. The first transportation pipe 54 communicates with the fourth pipe 7. The airflow containing the segments P flows in the first transportation pipe 54. The mixing blower 53 is provided to the first transportation pipe 54. The first transportation pipe 54 corresponds to an example of a transportation path.

The additive supplying portion 52 is coupled to not-illustrated additive cartridges that store the additive. The additive supplying portion 52 supplies the additive in the additive cartridge to the first transportation pipe 54. The additive supplying portion 52 stores the additive supplied from the additive cartridge. The additive supplying portion 52 includes a discharge portion 52a that sends the stored additive to the first transportation pipe 54.

The mixing blower 53 includes a not-illustrated rotating portion, such as a vane. The mixing blower 53 generates the airflow in the fourth pipe 7 and in the transporting portion 50. The mixing blower 53 mixes the segments P with the additive by the rotation of the rotating portion. In the meantime, the segments P and the additive that descend inside the fourth pipe 7 due to the airflow generated by the mixing blower 53 are suctioned into the first transportation pipe 54.

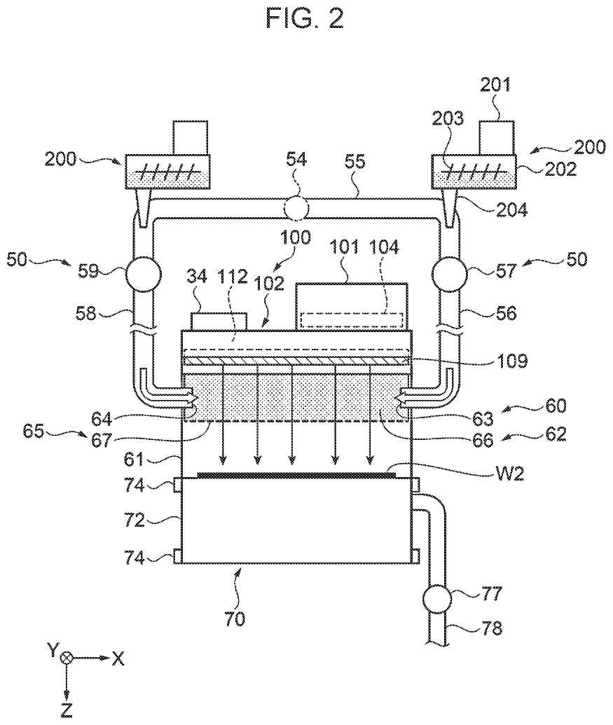

FIG. 2 illustrates configurations of the transporting portion 50, the sieve portion 60, and the second web forming portion 70. FIG. 2 is a diagram illustrating the transporting portion 50, the sieve portion 60, and the second web forming portion 70, which are viewed in the −Y direction. FIG. 2 illustrates sections of portions of a third transportation pipe 56 and a fourth transportation pipe 58, and of inside of a second housing 61 of the sieve portion 60. As illustrated in FIGS. 1 and 2, the transporting portion 50 includes a second transportation pipe 55, the third transportation pipe 56, two second supplying portions 200, a first blower 57, and a second blower 59. The second transportation pipe 55 communicates with the first transportation pipe 54, and extends in a direction parallel to the X-axis. The third transportation pipe 56 communicates with the second transportation pipe 55 at a position in the +X direction, and extends in the +Z direction. One of the two second supplying portions 200 is provided to the third transportation pipe 56. The first blower 57 is coupled to the third transportation pipe 56 at a position in the +Z direction of the one of the second supplying portions 200. The transporting portion 50 includes the fourth transportation pipe 58 and the second blower 59. The fourth transportation pipe 58 communicates with the second transportation pipe 55 at a position in the −X direction, and extends in the +Z direction. The other one of the two second supplying portions 200 is provided to the fourth transportation pipe 58. The second blower 59 is coupled to the fourth transportation pipe 58 at a position in the +Z direction of the other one of the second supplying portions 200. The second transportation pipe 55, the third transportation pipe 56, and the fourth transportation pipe 58 correspond to other examples of the transportation paths.

In the transporting portion 50, the airflow is generated in the first transportation pipe 54 by the mixing blower 53. The transporting portion 50 mixes the segments P with the supplied additive by using the generated airflow. The transporting portion 50 transports the segments P and the additive that are mixed together to the sieve portion 60. The segments P and the additive pass through the third transportation pipe 56 and the second transportation pipe 55 and are transported to the sieve portion 60. Powder is supplied from the second supplying portions 200 to the mixture of the segments P and the additive in the third transportation pipe 56 and the fourth transportation pipe 58 as appropriate. The mixture of the segments P and the additive passes through the third transportation pipe 56 and the fourth transportation pipe 58 and is transported to a container chamber 66 of a second drum portion 62 to be described later, which is located in the sieve portion 60.

As illustrated in FIG. 2, the transporting portion 50 is provided with the two second supplying portions 200. One of the second supplying portions 200 is provided in such a way as to be capable of supplying the powder into the third transportation pipe 56. The other second supplying portion 200 is provided in such a way as to be capable of supplying the powder into the fourth transportation pipe 58. The powder supplied from each second supplying portion 200 is an additive in the form of powder to be described later. Each of the two second supplying portions 200 includes a container body 201, a storage chamber 202, and a coupling conduit 204.

The container body 201 that contains the powder is attached to a position in the −Z direction of the storage chamber 202. The storage chamber 202 stores the powder supplied from the container body 201. The storage chamber 202 is provided with a delivery mechanism 203. The delivery mechanism 203 agitates the powder in the storage chamber 202 and transports the powder to the coupling conduit 204. One of the second supplying portions 200 supplies the powder into the third transportation pipe 56 through the corresponding coupling conduit 204. The other second supplying portion 200 supplies the powder into the fourth transportation pipe 58 through the corresponding coupling conduit 204.

The third transportation pipe 56 and the fourth transportation pipe 58 extend in the +Z direction toward the sieve portion 60. The powder supplied into the third transportation pipe 56 and the fourth transportation pipe 58 falls due to gravity. The suction power of each of the first blower 57 and the second blower 59 may be smaller than the suction power of the mixing blower 53.

As illustrated in FIG. 2, the sieve portion 60 includes the second drum portion 62, and the second housing 61 to house the second drum portion 62. The second drum portion 62 includes the container chamber 66 having a cylindrical shape. The container chamber 66 includes a first inlet 63 communicating with the third transportation pipe 56, and a second inlet 64 communicating with the fourth transportation pipe 58. The container chamber 66 can contain the mixture of the segments P and the additive introduced through the first inlet 63 or the second inlet 64, and the powder supplied from the second supplying portions 200. The container chamber 66 can contain powder supplied from the first supplying portion 100 to be described later. The second drum portion 62 is a sieve having a cylindrical shape, which is rotated by a motor. The second drum portion 62 is held by the second housing 61 in such a way as to be pivotally rotatable around a center axis of the cylindrical shape. The center axis of the cylindrical shape is a virtual axis that is parallel to the X-axis. The second drum portion 62 may be rotatably held by the first inlet 63 and the second inlet 64 provided to the second housing 61.

The second drum portion 62 includes a net 65 and functions as the sieve. The net 65 is an example of a peripheral surface constituting the container chamber 66. Using mesh 67 of the net 65, the second drum portion 62 allows fibers and particles smaller than mesh openings of the mesh 67 to pass therethrough. The fibers and the particles that pass through the mesh 67 fall in the +Z direction from the second drum portion 62. The configuration of the second drum portion 62 may be the same as the configuration of the first drum portion 41. The net 65 of the second drum portion 62 is formed of a wire net, expanded metal formed by stretching a metal plate provided with cuts, punching metal formed by providing a metal plate with through holes by using a press machine, and so forth.

The mixture of the segments P and the additive that passes through the transporting portion 50 and the powder supplied from the second supplying portions 200 are introduced from the first inlet 63 or the second inlet 64 into the container chamber 66 as indicated by open arrows in FIG. 2. The sieve portion 60 loosens the entwined mixture and disperses the mixture in the air. The dispersed mixture falls toward a second mesh belt 72. In the sieve portion 60, the powder supplied to the first supplying portion 100 to be described later is introduced to the container chamber 66 through the mesh 67 of the net 65. The sieve portion 60 sieves the mixture of the segments P, the additive, the powder supplied from the second supplying portions 200, and the powder supplied from the first supplying portion 100 onto the second mesh belt 72 of the second web forming portion 70.

The first supplying portion 100 is provided in such a way as to be capable of supplying the powder to the container chamber 66 of the second drum portion 62. The first supplying portion 100 is an example of a supplying portion. The powder supplied from the first supplying portion 100 is an additive in the form of powder to be described later. The powder supplied from the first supplying portion 100 may be the same as or different from the powder supplied from the second supplying portions 200. The first supplying portion 100 includes a first container body 101 and a supply mechanism 102.

The first container body 101 contains the powder supplied from the first supplying portion 100 to the container chamber 66 of the second drum portion 62. A bottom surface of the first container body 101 being a surface in the +Z direction thereof is provided with a not-illustrated outlet for discharging the contained powder. The first container body 101 includes an agitation mechanism 104 that can agitate the contained powder.

The supply mechanism 102 stores the powder discharged from the outlet of the first container body 101. The supply mechanism 102 includes an agitation mechanism 112 that can agitate the stored powder. The supply mechanism 102 includes a supply roller 109 located at a position in the +Z direction. The supply roller 109 supplies the powder to the sieve portion 60. The supply roller 109 is rotated by a not-illustrated motor. The supply roller 109 is rotated around an axis which is parallel to the X-axis. A width of the supply roller 109 parallel to the X-axis may preferably be equal to or larger than a width dimension of the after-mentioned second web W2 which is parallel to the X-axis.

As illustrated in FIGS. 1 and 2, the second web forming portion 70 is disposed at a position in the +Z direction of the second drum portion 62. The second web forming portion 70 is an example of a web forming portion. The second web forming portion 70 forms the second web W2 by accumulating the mixture of the segments P, the additive, the powder supplied from the second supplying portions 200, and the powder supplied from the first supplying portion 100, which have passed through the sieve portion 60. The second web forming portion 70 includes a first base material supply mechanism 150, the second mesh belt 72, stretching rollers 74, and a first suction mechanism 76.

The first base material supply mechanism 150 supplies a first base material M1 onto the second mesh belt 72. The first base material supply mechanism 150 includes a first support roller 152. The first support roller 152 supports the first base material M1 which is wound into a roll shape. The first support roller 152 supplies the first base material M1 onto the second mesh belt 72 by being rotated by a not-illustrated driving mechanism. When the molded body manufacturing apparatus 500 molds a molded body that does not include the first base material M1, the first base material supply mechanism 150 does not supply the first base material M1.

The second mesh belt 72 is an endless belt which is stretched around the stretching rollers 74. The second mesh belt 72 is transported in a direction indicated by a second arrow A2 in FIG. 1 by rotation of the stretching rollers 74. The second mesh belt 72 is made of a metal, a resin, a fabric, or a nonwoven fabric. The second mesh belt 72 is formed of a net in which openings in a predetermined size are arranged. Mesh of the second mesh belt 72 is formed into such a size that does not allow the mixture falling from the second drum portion 62 to pass through. The second mesh belt 72 moves at a second velocity V2 during normal operation of manufacturing the sheet S. The second web W2 is formed on the second mesh belt 72 or on the first base material M1.

As illustrated in FIG. 1, the first suction mechanism 76 is provided at a position in the +Z direction of the second mesh belt 72. The first suction mechanism 76 includes a suction blower 77 located in a suction flow channel 78. The first suction mechanism 76 can generate an airflow flowing in the +Z direction by use of suction power of the suction blower 77.

The second web W2 formed by the second web forming portion 70 is a flocculent body that contains a large amount of air. The second mesh belt 72 transports either the first base material M1 on which the second web W2 is mounted or the second web W2 to the molded body forming portion 80.

As illustrated in FIG. 1, the third supplying portion 300 is provided on a transportation route of the second mesh belt 72 and at a position in the +Y direction of the sieve portion 60. The third supplying portion 300 supplies powder to a surface in the −Z direction of the second web W2. The powder supplied from the third supplying portion 300 is an additive in the form of powder to be described later. The powder supplied from the third supplying portion 300 may be the same as the powder supplied from any of the second supplying portions 200 and the first supplying portion 100. The powder supplied from the first supplying portion 100, the powder supplied from the second supplying portions 200, and the powder supplied from the third supplying portion 300 may be different from one another.

The fourth supplying portion 400 is provided on the transportation route of the second mesh belt 72 and at a position in the +Y direction of the third supplying portion 300. The fourth supplying portion 400 feeds a liquid to the second web W2. The fourth supplying portion 400 is an example of a liquid feeding portion. The liquid fed from the fourth supplying portion 400 is an additive in a liquid form.

As illustrated in FIG. 1, the sixth humidifying portion 36 is provided on the transportation route of the second mesh belt 72 and at a position in the +Y direction of the fourth supplying portion 400. The sixth humidifying portion 36 can supply air containing mist to the second web W2. The supply of the mist to the second web W2 adjusts the amount of moisture contained in the second web W2.

As illustrated in FIG. 1, a second base material supply mechanism 160 is provided on the transportation route of the second mesh belt 72 and between the fourth supplying portion 400 and the sixth humidifying portion 36. The second base material supply mechanism 160 supplies a second base material M2 onto the second web W2 transported by the second mesh belt 72. The second base material supply mechanism 160 may supply the second base material M2 onto the second web W2 that is directly formed on the second mesh belt 72. The second base material supply mechanism 160 may supply the second base material M2 onto the second web W2 mounted on the first base material M1. The second base material supply mechanism 160 includes a second support roller 162 and a base material transportation roller 164. The second support roller 162 supports the second base material M2 which is wound into a roll shape. The second support roller 162 supplies the second base material M2 onto the second web W2 by being rotated by a not-illustrated driving mechanism. The base material transportation roller 164 transports the second base material M2 onto the second web W2. When the molded body manufacturing apparatus 500 molds a molded body that does not include the second base material M2, the second base material supply mechanism 160 does not supply the second base material M2.

In FIG. 1, the second base material supply mechanism 160 is installed between the fourth supplying portion 400 and the sixth humidifying portion 36. However, the present disclosure is not limited only to this configuration. The second base material supply mechanism 160 may be installed between the sixth humidifying portion 36 and the transferring portion 79 to be described later. In the following description, the first base material M1 on which the second web W2 is mounted, a laminated material formed by sandwiching the second web W2 between the first base material M1 and the second base material M2, and the second web W2 to which the second base material M2 is supplied will each be referred to as a multilayered body. The multilayered body corresponds to an example of a layered body. When the multilayered body is formed by sandwiching the second web W2 between the first base material M1 and the second base material M2, one of the first base material M1 and the second base material M2 corresponds to an example of second nonwoven paper.

The molded body manufacturing apparatus 500 includes the transferring portion 79 that transports either the second web W2 on the second mesh belt 72 or the multilayered body to the molded body forming portion 80. The transferring portion 79 includes a third mesh belt 79a, transfer rollers 79b, and a second suction mechanism 79c.

The second suction mechanism 79c includes a not-illustrated suction pump. The second suction mechanism 79c generates an airflow in the −Z direction on the third mesh belt 79a by use of suction power of the suction pump. The second suction mechanism 79c suctions the second web W2 or the multilayered body. The second web W2 or the multilayered body is detached from the second mesh belt 72 and adsorbs onto the third mesh belt 79a. The third mesh belt 79a moves along with rotation of the transfer rollers 79b. The third mesh belt 79a transports the second web W2 or the multilayered body to the molded body forming portion 80.

The molded body forming portion 80 forms the sheet S or the fiber aggregate body FC. The sheet S or the fiber aggregate body FC is an example of a molded body including fibers. The molded body forming portion 80 forms the sheet S by applying pressure and heat to the multilayered body transported by the transferring portion 79. Alternatively, the molded body forming portion 80 forms the fiber aggregate body FC by heating the second web W2 transported by the transferring portion 79. The molded body forming portion 80 binds the fibers in the mixture to one another with a bonding agent by applying heat to the segments P and the bonding agent included in the second web W2. The molded body forming portion 80 includes a pressure applying portion 82 and a heat applying portion 84.

The pressure applying portion 82 is formed of a pair of calender rollers 85. The pair of calender rollers 85 pinch the second web W2 or the multilayered body in between at a predetermined nipping pressure and apply the heat to the second web W2 or the multilayered body. A thickness of the second web W2 is reduced as a consequence of the heat application. Thus, a density of the second web W2 is increased. One of the pair of calender rollers 85 is a driving roller which is driven by a not-illustrated motor. The other one of the pair of calender rollers 85 is a driven roller. Being rotated by driving force of the motor, the calender rollers 85 transport the pressed second web W2 or the pressed multilayered body to the heat applying portion 84. When the molded body manufacturing apparatus 500 forms the fiber aggregate body FC, the pressure applying portion 82 does not have to be used.

The heat applying portion 84 includes a heat application roller, a hot press molding machine, a hot plate, a hot air blower, an infrared heater, a flash fixing device, and the like. The heat applying portion 84 illustrated in FIG. 1 includes a pair of heat application rollers 86.

The pair of heat application rollers 86 are used when forming the sheet S. The pair of heat application rollers 86 are heated to a preset temperature by using heaters installed inside or outside the rollers. The pair of heat application rollers 86 pinch the multilayered body pressed by the calender rollers 85 and applies the heat thereto, thus forming the sheet S. The sheet S includes a fiber aggregate layer L obtained by applying the heat and the pressure to the second web W2. The fiber aggregate layer L corresponds to an example of a fiber layer. One of the pair of heat application rollers 86 is a driving roller which is driven by a not-illustrated motor. The other one of the pair of heat application rollers 86 is a driven roller. The pair of heat application rollers 86 transport the heated sheet S to the cutting portion 90 by using driving force of the motor.

When the molded body forming portion 80 forms the fiber aggregate body FC, the hot air blower is employed as the heat applying portion 84. By heating the second web W2 with the hot air blower, the molded body forming portion 80 forms the fiber aggregate body FC in which the fibers are bound together with the bonding agent. The fiber aggregate body FC is transported to the cutting portion 90 by a not-illustrated transportation mechanism.

The cutting portion 90 cuts the sheet S or the fiber aggregate body FC formed by the molded body forming portion 80. The cutting portion 90 includes a first cutting portion 92 and a second cutting portion 94. The first cutting portion 92 cuts the sheet S or the fiber aggregate body FC in a direction intersecting with the Y-axis. The second cutting portion 94 cuts the sheet S or the fiber aggregate body FC having passed through the first cutting portion 92. The second cutting portion 94 is provided in such a way as to be capable of cutting the sheet S in a direction intersecting with a direction of transportation of the sheet S and in a direction parallel to the direction of transportation.

Accordingly, a single sheet S in a predetermined size or the fiber aggregate body FC in a predetermined size is formed. The single sheet S or the fiber aggregate body FC thus cut is discharged to the receiving portion 96. The receiving portion 96 includes a tray or a stacker on which the sheet S or the fiber aggregate body FC in the predetermined size is to be loaded.

The molded body manufacturing apparatus 500 may include a not-illustrated processing unit. The processing unit may be a press machine that forms processed portions 601 or through holes to be described later in the sheet S. The processing unit may be a partial cutter that partially cuts a surface of the sheet S. The processing unit may be a molding machine that processes the fiber aggregate body FC into a predetermined shape. The processing unit may be provided between the molded body forming portion 80 and the cutting portion 90. The processing unit may process the single sheet S or the fiber aggregate body FC, which is discharged to the receiving portion 96.

The manufacturer can manufacture various molded bodies by using the molded body manufacturing apparatus 500 illustrated in FIGS. 1 and 2. When manufacturing the various molded bodies, the manufacturer uses a raw material, various additives, and a base material in accordance with the type of molded body to be molded. The raw material is supplied from the raw material supplying portion 10 to the molded body manufacturing apparatus 500. The various additives are supplied by using at least one supplying portion out of the additive supplying portion 52, the first supplying portion 100, the second supplying portion 200, the third supplying portion 300, and the fourth supplying portion 400. When the additive is a liquid, the manufacturer supplies the additive by using the fourth supplying portion 400. The base material is supplied from the first base material supply mechanism 150 and the second base material supply mechanism 160.

The manufacturer manufactures the sheet S or the fiber aggregate body FC by supplying the raw material, the additives, and the base material described below to the molded body manufacturing apparatus 500. The sheet S or the fiber aggregate body FC is used when cultivating plants or fungi, such as mushrooms. The sheet S manufactured by using the raw material, the additives, and the base material mentioned below corresponds to an example of a culture sheet. The fiber aggregate body FC manufactured by using the raw material, and the additives mentioned below corresponds to an example of a fiber assembly.

Examples of the raw material include paper, cardboards, pulp, pulp sheets, sawdust, shavings, wood, and the like. Cellulose fibers are produced as the defibrated material by defibrating these raw materials. The cellulose fibers are fibers included in plant fibers of wood and the like, which are carbohydrates.

The additives include bonding agents and functional materials. Bonding agents are materials that bond the fibers. The functional materials are materials used for cultivating plants and fungi, which include fertilizers, hygroscopic agents, vermin repellents, insecticides, and the like. The bonding agents may have functions as the functional materials. The functional materials may have functions as the bonding agents.

The bonding agents include starch, protein-based adhesives, wood component-based adhesives, and the like. The protein-based adhesives include hide glues, casein glues, soybean glues, and the like. The wood component-based adhesives include Japanese lacquer, cellulose-based adhesives, lignin-based adhesives, and the like. The starch, the protein-based adhesives, and the wood component-based adhesives are natural adhesives. Such a natural adhesive corresponds to an example of a natural bonding agent. The manufacturer can manufacture the sheets S and the fiber aggregate bodies FC, which are environmentally friendly, by using the natural adhesives.

The bonding agent is preferably the starch. The starch is gelatinized when moisture and heat are added thereto. The gelatinized starch bonds the fibers to one another. The starch is an environmentally friendly material, which also functions as a fertilizer and a moisture retaining agent.

The starch may be added in a liquid form. The liquid starch is supplied to the sheet S or the fiber aggregate body FC by using the fourth supplying portion 400.

Such a bonding agent is fused by heat application and bonds the fibers to one another. The bonding agent is mixed with the fibers, but does not bond the fibers to one another unless the bonding agent is heated to a fusing temperature. The bonding agent is supplied from the additive supplying portion 52.

Such a functional material is preferably a fertilizer. Examples of the fertilizer include a nitrogen fertilizer, a phosphate fertilizer, a potassium fertilizer, and the like. Examples of the nitrogen fertilizer include ammonium sulfate, ammonium chloride, ammonium nitrate, and the like. Examples of the phosphate fertilizer include calcium superphosphate, calcium double superphosphate or calcium tripe superphosphate, a fused phosphate fertilizer, and the like. Examples of the potassium fertilizer include potassium chloride, potassium nitrate, and the like. The fertilizer may be a mixed fertilizer prepared by mixing two or more types of the fertilizers cited above. The fertilizer corresponds to an example of a nutrient. The fertilizer is supplied to the sheet S or the fiber aggregate body FC by using at least one supplying portion out of the first supplying portion 100, the second supplying portion 200, the third supplying portion 300, and the fourth supplying portion 400.

The functional material may be an ameliorant. The ameliorant is a pH adjuster, for instance. Examples of the pH adjuster include organic lime, wood ash, quicklime, slaked lime, and the like. The ameliorant is supplied to the sheet S or the fiber aggregate body FC by using at least one supplying portion out of the first supplying portion 100, the second supplying portion 200, the third supplying portion 300, and the fourth supplying portion 400.

The functional material may be a vermin repellent or an insecticide. Examples of the vermin repellent and the insecticide include publicly known chemically synthesized agents, such as camphor and naphthalene, and natural materials, such as camphor tree powder and cypress tree powder. A mixture of the vermin repellent and the insecticide can also be used. The vermin repellent and the insecticide are supplied to the sheet S or the fiber aggregate body FC by using at least one supplying portion out of the first supplying portion 100, the second supplying portion 200, the third supplying portion 300, and the fourth supplying portion 400.

The functional material may be a moisture retaining material. Examples of the moisture retaining material include a copolymer of acrylic acid and vinyl alcohol, an alkaline hydrolysate of a graft copolymer of starch and acrylonitrile, a sodium acrylate polymer, and the like. The moisture retaining agent may be a water absorbing polymer mixture prepared by mixing two or more types of moisture absorbing polymers. The moisture retaining agent is supplied to the sheet S or the fiber aggregate body FC by using at least one supplying portion out of the first supplying portion 100, the second supplying portion 200, the third supplying portion 300, and the fourth supplying portion 400.

The functional material may be a Lactobacillus-containing material or a fermentation accelerator. Lactobacillus can suppress the activity of molds and aerobic bacteria which cause decay. The fermentation accelerator accelerates the activity of microbes, such as Lactobacillus. The Lactobacillus-containing material or the fermentation accelerator is supplied to the sheet S or the fiber aggregate body FC by using at least one supplying portion out of the first supplying portion 100, the second supplying portion 200, the third supplying portion 300, and the fourth supplying portion 400.

The functional material may be charcoal. Examples of the charcoal include wood charcoal, bamboo charcoal, coconut shell charcoal, and the like. The charcoal can suppress an outbreak of miscellaneous bacteria or insects. The charcoal is supplied to the sheet S or the fiber aggregate body FC by using at least one supplying portion out of the first supplying portion 100, the second supplying portion 200, the third supplying portion 300, and the fourth supplying portion 400.

The base material supplied from the first base material supply mechanism 150 is a nonwoven fabric. The nonwoven fabric is a fabric sheet or a web in which the fibers are oriented either in one direction or at random. The fibers included in the nonwoven fabric are chemically or mechanically bonded to one another. The chemical bonding is adhesion by using a binding resin. The mechanical bonding is bonding by entwining the fibers under a flow of water or the like. The nonwoven fabric may be the sheet S formed in advance by using the molded body manufacturing apparatus 500. In this case, a binding agent to bind the fibers may be a thermoplastic resin or a thermosetting resin. Examples of the binding resin include AS resin, ABS resin, polypropylene, polyethylene, polyvinyl chloride, polystyrene, acrylic resin, polyester resin, polyethylene terephthalate, polyphenylene ether, polybutylene terephthalate, polyamide, polycarbonate, polyacetal, polyphenylene sulfide, polyethylene ether ketone, and the like. The nonwoven fabric corresponds to an example of nonwoven paper.

The base material supplied from the second base material supply mechanism 160 is a nonwoven fabric. The nonwoven fabric is a fabric sheet or a web in which the fibers are oriented either in one direction or at random. The fibers included in the nonwoven fabric are chemically or mechanically bonded to one another. The chemical bonding is adhesion by using a binding resin. The mechanical bonding is bonding by entwining the fibers under a flow of water or the like. The nonwoven fabric may be the sheet S formed in advance by using the molded body manufacturing apparatus 500. In this case, a binding agent to bind the fibers may be a thermoplastic resin or a thermosetting resin. Examples of the binding resin include AS resin, ABS resin, polypropylene, polyethylene, polyvinyl chloride, polystyrene, acrylic resin, polyester resin, polyethylene terephthalate, polyphenylene ether, polybutylene terephthalate, polyamide, polycarbonate, polyacetal, polyphenylene sulfide, polyethylene ether ketone, and the like. The nonwoven fabric corresponds to another example of the nonwoven paper.

The first base material M1 supplied from the first base material supply mechanism 150 and the second base material M2 supplied from the second base material supply mechanism 160 may be the same nonwoven fabric or different nonwoven fabrics.

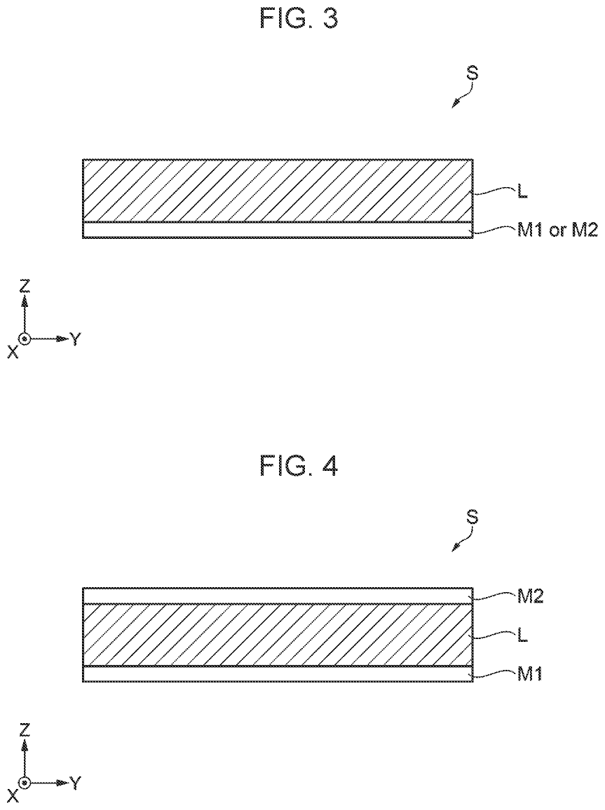

FIGS. 3 and 4 illustrate configurations of the sheet S to be formed by the molded body manufacturing apparatus 500 by using the raw material, the additives, and the base material mentioned above. FIG. 3 illustrates the configuration of the sheet S formed either from the fiber aggregate layer L and the first base material M1 or from the fiber aggregate layer L and the second base material M2. FIG. 4 illustrates the configuration of the sheet S formed of the first base material M1, the fiber aggregate layer L, and the second base material M2.

The sheet S illustrated in FIG. 3 is formed by using the multilayered body formed by laminating the second web W2 on the first base material M1. Alternatively, the sheet S illustrated in FIG. 3 is formed by using the multilayered body formed by laminating the second base material M2 on the second web W2 that is formed on the second mesh belt 72. The molded body forming portion 80 forms the sheet S including the fiber aggregate layer L by applying the heat and the pressure to the multilayered body.

The sheet S illustrated in FIG. 4 is formed by using the multilayered body formed by laminating the second web W2 on the first base material M1 and then laminating the second base material M2 on the second web W2. The molded body forming portion 80 forms the sheet S including the fiber aggregate layer L by applying the heat and the pressure to the second web W2.

Each of the fiber aggregate layers L illustrated in FIGS. 3 and 4 includes the fibers and the bonding agent. Each of the fiber aggregate layers L illustrated in FIGS. 3 and 4 may include the functional material. The fibers included in each fiber aggregate layer L are cellulose fibers. The fibers included in the fiber aggregate layer L are 50% by weight or more and 90% by weight or less. The content of fibers included in the fiber aggregate layer L is appropriately adjusted by changing the content of the bonding agent and the contents of the functional materials therein.

The bonding agent included in the fiber aggregate layer L is the natural adhesive. The bonding agent included in the fiber aggregate layer L is preferably 10% by weight or more and 30% by weight or less. The content of the bonding agent does not depend on the material of the bonding agent. When the content of the bonding agent is less than 10% by weight, the bonding force between the fibers becomes insufficient. For example, when water is added to the sheet S, the fiber aggregate layer L gets swollen and hardly maintains its shape. On the other hand, when the content of the bonding agent is more than 30% by weight, holes in the fiber aggregate layer L are reduced. The reduction of the holes in the fiber aggregate layer L leads to insufficient growth of plant roots and fungal filaments when used as a culture sheet.

A density of the fiber aggregate layer L is preferably 0.1 g/cm³ or more and 0.7 g/cm³ or less. The strength of the sheet S is reduced when the density of the fiber aggregate layer L is less than 0.1 g/cm³. A user cannot handle the sheet S easily when the strength of the sheet S is reduced. On the other hand, when the density of the fiber aggregate layer L is more than 0.7 g/cm³, the holes in the fiber aggregate layer L are reduced. The reduction of the holes in the fiber aggregate layer L hinders the growth of plant roots and fungal filaments.

The first base material M1 or the second base material M2 illustrated in FIG. 3 is a nonwoven fabric. The nonwoven fabric may be formed of the fibers and the bonding agent constituting the fiber aggregate layer L. The nonwoven fabric is preferably formed of fibers that are different from the fibers constituting the fiber aggregate layer L. The nonwoven fabric is preferably formed of the bonding agent that is different from the bonding agent constituting the fiber aggregate layer L.

As described above, the sheet S includes the fiber aggregate layer L provided with the cellulose fibers and the natural adhesive that bonds the cellulose fibers, and the nonwoven fabric that supports the fiber aggregate layer L.

Since the nonwoven fabric prevents evaporation of the moisture retained in the fiber aggregate layer L, the sheet S can easily retain the moisture. Moreover, the nonwoven fabric can prevent deformation due to swelling of the fiber aggregate layer L that absorbs the moisture, thereby maintaining the shape of the sheet.

The fiber aggregate layer L may include a functional material. The functional material included in the fiber aggregate layer L is preferably the fertilizer. One of more types of the above-mentioned functional materials may be added to the fiber aggregate layer L. The functional materials to be included in the fiber aggregate layer L are appropriately added in accordance with the use application of the sheet S.

The fiber aggregate layer L preferably includes the fertilizer.

Since the fiber aggregate layer L includes the fertilizer, the sheet S can grow plants easily.

The sheet S illustrated in FIG. 4 includes the first base material M1, the fiber aggregate layer L, and the second base material M2. The first base material M1 and the second base material M2 cover the fiber aggregate layer L. The fiber aggregate layer L of the sheet S illustrated in FIG. 4 includes the cellulose fibers and the natural adhesive as with the fiber aggregate layer L of the sheet S illustrated in FIG. 3. The fiber aggregate layer L illustrated in FIG. 4 may include a functional material. Each of the first base material M1 and the second base material M2 is a nonwoven fabric. The first base material M1 and the second base material M2 may be the same nonwoven fabric. Nonetheless, the first base material M1 and the second base material M2 are preferably different nonwoven fabrics. When the first base material M1 and the second base material M2 are formed of different nonwoven fabrics, an upper surface and a lower surface of the sheet S can have different properties from each other.

The sheet S includes the second base material M2 which is located on the fiber aggregate layer L to cover the fiber aggregate layer L.

The sheet S can prevent evaporation of the moisture from the upper surface and the lower surface of the fiber aggregate layer L. The sheet S can retain the moisture more easily. Moreover, since the sheet S retains the nonwoven fabrics on the upper surface and the lower surface of the fiber aggregate layer L, the sheet S is capable of more efficiently suppressing the deformation due to the swelling of the fiber aggregate layer L attributed to the moisture.

The bonding agent included in the fiber aggregate layer L is preferably the starch. Moreover, the content of the starch in the fiber aggregate layer L is preferably 10% by weight or more and 30% by weight or less.

The starch not only serves as the bonding agent in the fiber aggregate layer L, but can also be utilized as the fertilizer and the moisture retaining agent. Accordingly, plants and fungi can grow more easily. Moreover, since the content of the starch is 10% by weight or more and 30% by weight or less, bonding force between the fibers in the fiber aggregate layer L is maintained without hindering the growth of plant roots and fungal filaments.

The bonding agent included in the fiber aggregate layer L bonds the fiber aggregate layer L to the first base material M1. As a consequence of application of the heat and the pressure to the multilayered body by using the molded body forming portion 80, the bonding agent included in the fiber aggregate layer L sticks the fibers in the fiber aggregate layer L to the first base material M1. The fiber aggregate layer L is bonded to the first base material M1 by using the bonding agent. When the first base material M1 includes the bonding agent such as the binding resin, the bonding agent included in the first base material M1 bonds the fiber aggregate layer L to the first base material M1. As a consequence of application of the heat and the pressure to the multilayered body by using the molded body forming portion 80, the bonding agent included in the first base material M1 sticks the fibers in the fiber aggregate layer L to the first base material M1.

The bonding agent included in the fiber aggregate layer L bonds the fiber aggregate layer L to the second base material M2. As a consequence of application of the heat and the pressure to the multilayered body by using the molded body forming portion 80, the bonding agent included in the fiber aggregate layer L sticks the fibers in the fiber aggregate layer L to the second base material M2. The fiber aggregate layer L is bonded to the second base material M2 by using the bonding agent. When the second base material M2 includes the bonding agent such as the binding resin, the bonding agent included in the second base material M2 bonds the fiber aggregate layer L to the second base material M2. As a consequence of application of the heat and the pressure to the multilayered body by using the molded body forming portion 80, the bonding agent included in the second base material M2 sticks the fibers in the fiber aggregate layer L to the second base material M2.

When the first base material M1 is bonded to the fiber aggregate layer L, a bonding layer is formed between the first base material M1 and the fiber aggregate layer L. The bonding layer is a layer formed of the bonding agent. Formation of the bonding layer improves a water absorbing property of the sheet S, thereby suppressing the swelling of the fiber aggregate layer L due to the moisture. The bonding layer is formed of the bonding agent included in the fiber aggregate layer L or the bonding agent included in the first base material M1.

When the second base material M2 is bonded to the fiber aggregate layer L, a bonding layer is formed between the second base material M2 and the fiber aggregate layer L. The bonding layer is a layer formed of the bonding agent. Formation of the bonding layer improves a water absorbing property of the sheet S, thereby suppressing the swelling of the fiber aggregate layer L due to the moisture. The bonding layer is formed of the bonding agent included in the fiber aggregate layer L or the bonding agent included in the second base material M2.

The first base material M1 and the fiber aggregate layer L illustrated in FIG. 3 are bonded to each other by using the bonding agent included in the fiber aggregate layer L. When the first base material M1 includes the bonding agent such as the binding resin, the bonding agent included in the first base material M1 bonds the fiber aggregate layer L to the first base material M1. The second base material M2 and the fiber aggregate layer L are bonded to each other by using the bonding agent included in the fiber aggregate layer L. When the second base material M2 includes the bonding agent such as the binding resin, the bonding agent included in the second base material M2 bonds the fiber aggregate layer L to the second base material M2. Meanwhile, the first base material M1, the fiber aggregate layer L, and the second base material M2 illustrated in FIG. 4 are bonded to one another by using the bonding agent included in the fiber aggregate layer L. When the first base material M1 includes the bonding agent such as the binding resin, the bonding agent included in the first base material M1 bonds the fiber aggregate layer L to the first base material M1. When the second base material M2 includes the bonding agent such as the binding resin, the bonding agent included in the second base material M2 bonds the fiber aggregate layer L to the second base material M2. The fiber aggregate layer L is supported by the nonwoven fabrics by bonding the fiber aggregate layer L to the nonwoven fabrics by use of the bonding agent included in the fiber aggregate layer L.

A density of each nonwoven fabric is preferably higher than the density of the fiber aggregate layer L. Meanwhile, the nonwoven fabric preferably has higher water resistance than that of the fiber aggregate layer L. Here, the water resistance means less transformation attributed to the moisture. The transformation attributed to the moisture includes volume expansion attributed to the moisture. For example, the water resistance is evaluated based on a temporal change in contact angle of water relative to the nonwoven fabric. The water resistance is higher when the temporal change in contact angle is smaller. The water resistance is lower when the temporal change in contact angle is larger.

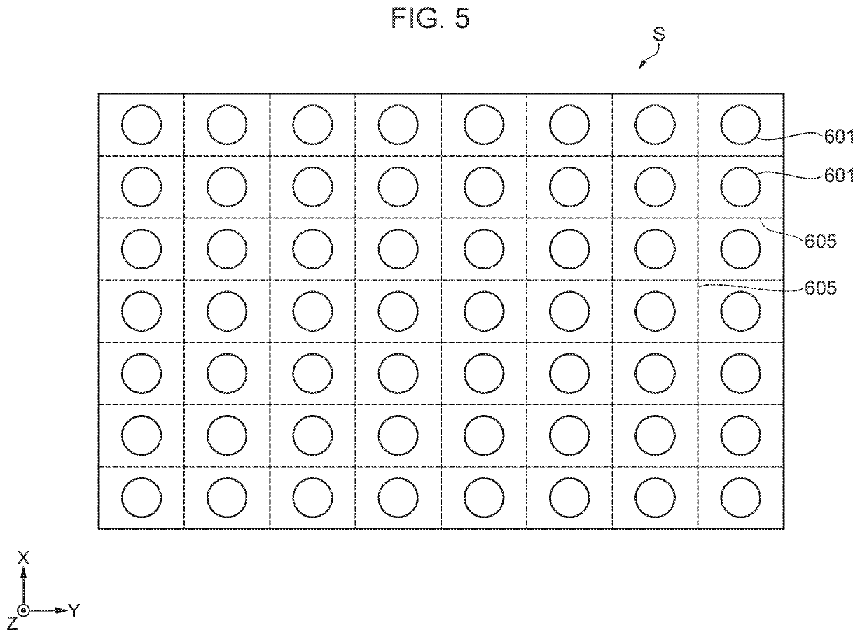

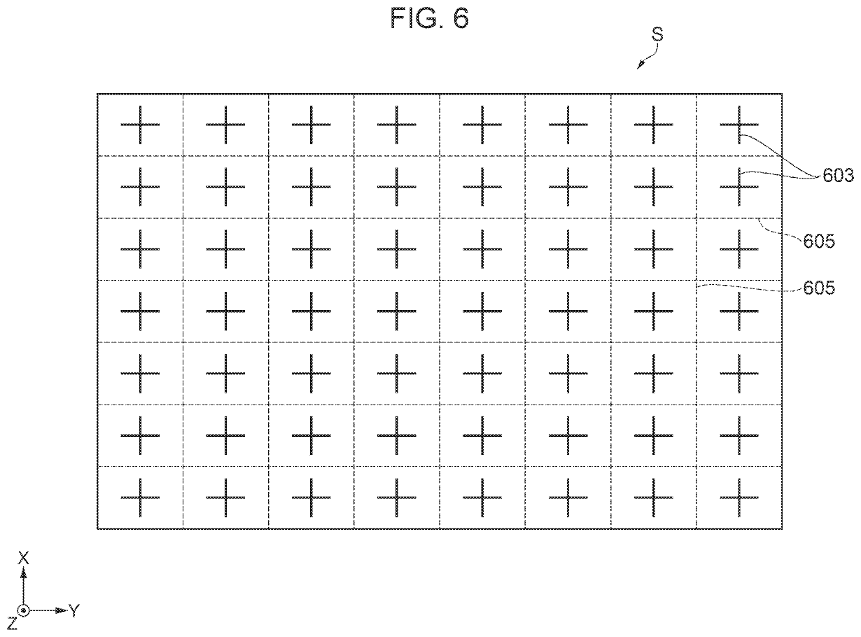

FIGS. 5 and 6 illustrate configurations in which the sheet S illustrated in FIG. 3 or 4 is subjected to surface processing. The surface of each of the sheets S illustrated in FIGS. 5 and 6 is the surface of any one of the first base material M1, the fiber aggregate layer L, and the second base material M2. The surface subjected to the surface processing is appropriately selected in accordance with the use application of the sheet S. The surface subjected to the surface processing is preferably the surface of the first base material M1 or the second base material M2. The surfaces of the first base material M1 and the second base material M2 have higher degrees of smoothness than that of the surfaces of the fiber aggregate layer L. The surface of the first base material M1 or the second base material M2 subjected to the surface processing can easily undergo uniform processing as compared to the surface of the fiber aggregate layer L subjected to the surface processing.

The surface of the sheet S illustrated in FIG. 5 is provided with the processed portions 601. A thickness of the sheet S at each processed portion 601 is smaller than a thickness of the sheet S at portions other than the processed portions 601. The processed portions 601 are formed into dents relative to the surface of the sheet S. Each processed portion 601 illustrated in FIG. 5 corresponds to an example of a recess. The surface of the sheet S illustrated in FIG. 5 includes the processed portions 601 that are aligned along the X-axis and the Y-axis. The processed portions 601 may be aligned or not aligned along the X-axis and the Y-axis. The layout of the processed portions 601 may be appropriately changed in accordance with the use application of the sheet S. Meanwhile, the processed portions 601 illustrated in FIG. 5 are provided in a matrix of seven pieces along the X-axis and eight pieces along the Y-axis each. However, the matrix layout is not limited only to this configuration. The number of the processed portions 601 can be appropriately changed in accordance with the use application of the sheet S.

The surface of the sheet S illustrated in FIG. 5 is provided with cutting line portions 605. The user of the sheet S can cut the sheet S into pieces by using the cutting line portions 605. Although the cutting line portions 605 illustrated in FIG. 5 are provided in such a way that the processed portions 601 can be cut into single pieces, the layout of the cutting line portions 605 is not limited only to this configuration. The cutting line portions 605 may be provided in such a way that the processed portion 601 can be cut into groups each including two or more pieces. The cutting line portions 605 illustrated in FIG. 5 are provided along the X-axis and the Y-axis. However, the layout of the cutting line portions 605 is not limited only to this configuration. The cutting line portions 605 do not have to be provided along the X-axis. The cutting line portions 605 do not have to be provided along the Y-axis. Although the cutting line portion 605 do not have to be provided, the sheet S becomes more convenient as a consequence of being provided with the cutting line portions 605.

The processed portions 601 are formed by using a press processing machine, for example. The press processing machine may be provided to the molded body forming portion 80 of the molded body manufacturing apparatus 500. The press processing machine may also function as the pressure applying portion 82 and the heat applying portion 84 of the molded body manufacturing apparatus 500. The press processing machine may be provided between the cutting portion 90 and the receiving portion 96. The press processing machine may process the sheet S received by the receiving portion 96.

The processed portions 601 may be provided either in the surface of the sheet S illustrated in FIG. 3 or in the surface of the sheet S illustrated in FIG. 4.

Alternatively, the processed portions 601 may be provided in any of the surface of the first base material M1, the surface of the second base material M2, and the surfaces of the fiber aggregate layer L. The processed portions 601 are preferably provided in the surface of the second base material M2 of the sheet S illustrated in FIG. 4. The sheet S illustrated in FIG. 4 easily undergoes the surface processing by using the press processing machine.

The second base material M2 of the sheet S includes the processed portions 601.

The sheet S can hold seeds of plants or spores of fungi by using the processed portions 601, so that the user can fix the seeds of the plants and the spores of the fungi easily.

The surface of the sheet S illustrated in FIG. 6 is provided with cut portions 603. The cut portions 603 are partially cut regions on the surface of the sheet S. A cutting depth of each cut portion 603 is appropriately set in accordance with the use application of the sheet S. Each cut portion 603 illustrated in FIG. 6 is cut into a cross shape. However, the cut shape is not limited only to this configuration. The cut shape of the cut portions 603 can be changed as appropriate. Each cut portion 603 illustrated in FIG. 6 corresponds to an example of an incision. The surface of the sheet S illustrated in FIG. 6 includes the cut portions 603 that are aligned along the X-axis and the Y-axis. The cut portions 603 may be aligned or not aligned along the X-axis and the Y-axis. The layout of the cut portions 603 may be appropriately changed in accordance with the use application of the sheet S. Meanwhile, the cut portions 603 illustrated in FIG. 6 are provided in a matrix of seven pieces along the X-axis and eight pieces along the Y-axis each. However, the matrix layout is not limited only to this configuration. The number of the cut portions 603 can be appropriately changed in accordance with the use application of the sheet S.

The cut portions 603 are formed by using a wheel cutter, for example. The wheel cutter forms the cut portions 603 by bringing its blade into contact with the surface of the sheet S. The wheel cutter may be provided between the cutting portion 90 and the receiving portion 96. The wheel cutter may process the sheet S received by the receiving portion 96.

The cut portions 603 may be provided either in the surface of the sheet S illustrated in FIG. 3 or in the surface of the sheet S illustrated in FIG. 4.

Alternatively, the cut portions 603 may be provided in any of the surface of the first base material M1, the surface of the second base material M2, and the surfaces of the fiber aggregate layer L. The cut portions 603 are preferably provided in the surface of the second base material M2 of the sheet S illustrated in FIG. 4. It is easier to form the cut portions 603 into similar shapes by processing the cut portions 603 in the sheet S illustrated in FIG. 4.

The second base material M2 of the sheet S includes incisions.

The sheet S can hold seeds of plants or spores of fungi in the incisions. Thus, the user of the sheet S can fix the seeds of the plants and the spores of the fungi easily.

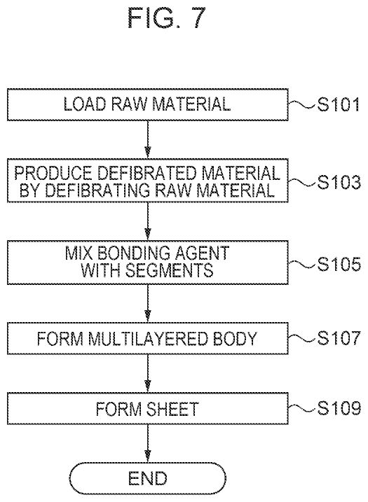

FIG. 7 illustrates a flowchart for forming the sheet S by using the molded body manufacturing apparatus 500. The sheet S to be used when cultivating plants or fungi, such as mushrooms, is formed by the following steps.

In step S101, the manufacturer loads the raw material into the raw material supplying portion 10 of the molded body manufacturing apparatus 500. Examples of the raw material to be loaded include paper such as used paper, cardboards, pulp, pulp sheets, sawdust, shavings, wood, and the like. These raw materials include cellulose fibers.

The raw material loaded into the raw material supplying portion 10 is defibrated by the defibrating portion 20 in step S103. The defibrating portion 20 performs defibration in accordance with the dry method. The defibrating portion 20 produces the defibrated material by defibrating the raw material. The defibrated material defibrated by the defibrating portion 20 is passed through the first web forming portion 45 and the rotating body 49. Thus, the segments P are formed. The segments P include the cellulose fibers.

The segments P are transported to the transporting portion 50. The bonding agent supplied from the additive supplying portion 52 is added to the segments P. The bonding agent to be added is the natural adhesive. The natural adhesive is preferably the starch. In step S105, the segments P and the bonding agent are mixed by using the mixing blower 53 in the transporting portion 50.

The additive is appropriately added to the segments P mixed with the bonding agent. The transporting portion 50 is provided with the first supplying portion 100 and the second supplying portions 200. The fertilizer and the functional materials may be added to the mixture of the segments P and the bonding agent. The mixture of the segments P and the bonding agent is transported to the second web forming portion 70.

The mixture of the segments P and the bonding agent transported to the second web forming portion 70 is laminated on the second mesh belt 72 or on the first base material M1. The laminated material to be laminated on the second mesh belt 72 or on the first base material M1 is the second web W2. When the first base material M1 is transported onto the second mesh belt 72, a multilayered body including the first base material M1 and the second web W2 is formed in step S107. When the second web W2 is formed on the second mesh belt 72, the second base material M2 is transported onto the second web W2, and the multilayered body of the second web W2 and the second base material M2 is formed in step S107. The second base material M2 may be transported onto the multilayered body including first base material M1 and the second web W2, and a multilayered body including the first base material M1, the second web W2, and the second base material M2 may be formed in step S107.

The first base material M1 to be transported is the nonwoven fabric. The second base material M2 to be transported is the nonwoven fabric. When transporting the first base material M1 and the second base material M2, the first base material M1 and the second base material M2 may be the same nonwoven fabric or different nonwoven fabrics.

The additives may be added from either the third supplying portion 300 or the fourth supplying portion 400 to the formed multilayered body. The additives to be added are the fertilizer and the functional materials. The third supplying portion 300 or the fourth supplying portion 400 may add the bonding agent.

The formed multilayered body is transported to the molded body forming portion 80. In step S109, the molded body forming portion 80 forms the sheet S by applying the heat and the pressure to the multilayered body. The molded body forming portion 80 forms the fiber aggregate layer L by applying the heat and the pressure to the second web W2. The sheet S to be formed includes the first base material M1 and the fiber aggregate layer L. Alternatively, the formed sheet S includes the second base material M2 and the fiber aggregate layer L. Otherwise, the formed sheet S includes the first base material M1, the fiber aggregate layer L, and the second base material M2.

The molded body forming portion 80 may process the processed portions 601 in the surface of the sheet S. Alternatively, the molded body forming portion 80 may subject the sheet S mounted on the receiving portion 96 to the surface processing. The processed portions 601 illustrated in FIG. 5 or the cut portions 603 illustrated in FIG. 6 are formed by subjecting the sheet S to the surface processing. The sheet S may be provided with the cutting line portions 605 illustrated in FIG. 5 or 6.

As described above, according to the method of manufacturing the sheet S, the raw material that includes the cellulose fibers is defibrated by dry defibration, and the mixture is produced by mixing the cellulose fibers defibrated by the dry defibration with the natural adhesive. The multilayered body is produced by using an accumulated material obtained by accumulating the produced mixture, and any of the first base material M1 and the second base material M2. Then, the sheet S is produced by applying the heat and the pressure to the multilayered body.

The molded body manufacturing apparatus 500 produces the multilayered body by using the second web W2 and any of the first base material M1 and the second base material M2, and then manufactures the sheet S by applying the heat and the pressure thereto. Adhesion between the fiber aggregate layer L and either the first base material M1 or the second base material M2 is thus improved. In the meantime, since the molded body manufacturing apparatus 500 performs the heat application, the molded body manufacturing apparatus 500 can conduct sterilization of the sheet S in parallel.

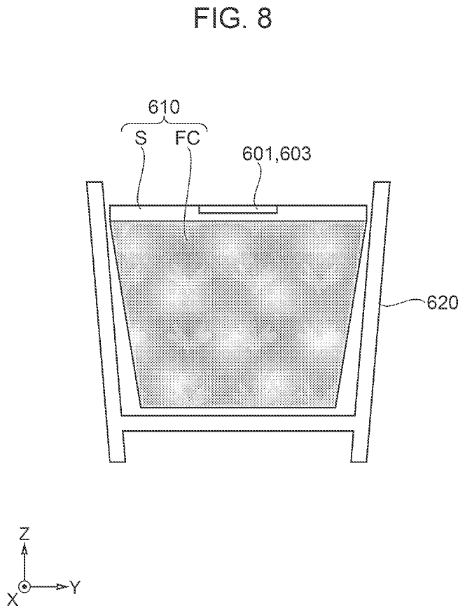

FIG. 8 illustrates a configuration of a fiber processed product 610 including the sheet S. The fiber processed product 610 illustrated in FIG. 8 is put into a container 620 and is then used, for example. The container 620 is a plant pot, for example. The container 620 may be molded by processing the sheet S. The fiber processed product 610 corresponds to an example of a culture kit.

The fiber processed product 610 is constituted of the sheet S and the fiber aggregate body FC. As this sheet S, either the sheet S illustrated in FIG. 3 or the sheet S illustrated in FIG. 4 is used. As illustrated in FIG. 8 the sheet S used in the fiber processed product 610 may be provided with the processed portions 601 illustrated in FIG. 5 or the cut portions 603 illustrated in FIG. 6. The sheet S used in the fiber processed product 610 may be provided with the cutting line portions 605 illustrated in FIGS. 5 and 6. The sheet S used in the fiber processed product 610 may be provided with a through hole that penetrates the sheet S. The through hole is covered with the fiber aggregate body FC. The sheet S may be provided with one of or two or more of the processed portions 601, the cut portions 603, and the through holes. The plant seeds or the fungi spores can be buried in the processed portions 601, the cut portion 603, or the through holes.

The fiber aggregate body FC is a flocculent aggregate body that includes the cellulose fibers. The fiber aggregate body FC may include a fertilizer and a functional material. Although the fertilizer included in the fiber aggregate body FC may be the same as the fertilizer included in the sheet S, these fertilizers are preferably different from each other. The content of the fertilizer included in the fiber aggregate body FC may be equal to the content of the fertilizer included in the sheet S. Nonetheless, the content of the fertilizer included in the fiber aggregate body FC is preferably larger than the content of the fertilizer included in the sheet S. For example, the fertilizer included in the sheet S can reduce an influence on sprouting when the content of the fertilizer included in the sheet S is made smaller than the content of the fertilizer included in the fiber aggregate body FC. The functional material included in the fiber aggregate body FC may be the same as the functional material included in the sheet S. Nonetheless, these functional materials are preferably different from each other. For example, the functional material in the sheet S includes a functional material used for sprouting while the functional material in the fiber aggregate body FC includes a functional material used for growth of roots and stems. The content of the functional material included in the fiber aggregate body FC may be equal to the content of the functional material included in the sheet S. Nonetheless, the content of the functional material included in the fiber aggregate body FC is preferably larger than the content of the functional material included in the sheet S.

The bonding agent included in the fiber aggregate body FC is a natural adhesive. The bonding agent included in the fiber aggregate body FC is preferably the starch. The bonding agent included in the fiber aggregate body FC may be different from the bonding agent included in the sheet S. However, these bonding agents are preferably the same bonding agent. When the bonding agent included in the fiber aggregate body FC and the bonding agent included in the sheet S are the same bonding agent, the fiber aggregate body FC and the sheet S are easily bonded to each other. The bonding agent included in the fiber aggregate body FC corresponds to an example of a first natural bonding agent. The bonding agent included in the sheet S corresponds to an example of a second natural bonding agent.

The fiber aggregate body FC is partially covered with the sheet S. The fiber aggregate body FC is attached to the sheet S. The fiber aggregate body FC and the sheet S are bonded to each other by using the bonding agent included in the sheet S or the fiber aggregate body FC. A density of the fiber aggregate body FC is lower than the density of the fiber aggregate layer L included in the sheet S. The fiber aggregate body FC can grow plant roots and fungal filaments more than the sheet S does.

The fiber processed product 610 includes the fiber aggregate body FC, which has the cellulose fibers, and the bonding agent to bond the cellulose fibers. The fiber processed product 610 also includes the sheet S, which has the fiber aggregate layer L that has the cellulose fibers and the bonding agent to bond the cellulose fibers, and the nonwoven fabric that supports the fiber aggregate layer L. Here, the sheet S covers the fiber aggregate body FC.

The fiber aggregate body FC has numerous void spaces therein. Accordingly, plant roots and fungal filaments can grow easily in the fiber aggregate body FC. Meanwhile, since the sheet S covers the fiber aggregate body FC, the sheet S can suppress evaporation of the moisture in the fiber aggregate body FC.

What is claimed is:

1. A culture sheet comprising:
a fiber layer including
cellulose fibers and
a natural bonding agent that bonds the cellulose fibers; and
nonwoven paper that supports the fiber layer.

2. The culture sheet according to claim 1, wherein the fiber layer includes a nutrient.

3. The culture sheet according to claim 1, further comprising:
second nonwoven paper that covers, on the fiber layer, the fiber layer.

4. The culture sheet according to claim 3, wherein the second nonwoven paper includes a recess.

5. The culture sheet according to claim 3, wherein the second nonwoven paper includes an incision.

6. The culture sheet according to claim 1, wherein the natural bonding agent is starch, and
a content of the starch is 10% by weight or more and 30% by weight or less.

7. A culture kit comprising:
a fiber assembly including
cellulose fibers and
a first natural bonding agent that bonds the cellulose fibers; and
a sheet including
a fiber layer including
cellulose fibers and
a second natural bonding agent that bonds the cellulose fibers and
nonwoven paper that supports the fiber layer, wherein
the sheet covers the fiber assembly.

8. A method of manufacturing a culture sheet comprising:
defibrating a raw material that includes cellulose fibers by dry defibration;
producing a mixture by mixing the cellulose fibers defibrated by the dry defibration with a natural bonding agent;
producing a layered body by using the mixture produced and nonwoven paper; and
producing a sheet by applying heat and pressure to the layered body.
